(19) United States
(12) Patent Application Publication
(10) Pub. No.: US 2024/0088499 A1
(43) Pub. Date: Mar. 14, 2024

(54) TRACTION BATTERY PACK ASSEMBLY HAVING A BARRIER BETWEEN CELL STACKS

(71) Applicant: Ford Global Technologies, LLC, Dearborn, MI (US)

(72) Inventors: Di Zhu, Novi, MI (US); Christopher Steven Baldwin, Royal Oak, MI (US); John Peter Bilezikjian, Canton, MI (US); Bhaskara Rao Boddakayala, Troy, MI (US); Mohammadreza Eftekhari, Novi, MI (US); Giriraj Srinivasan, Troy, MI (US); Gene Willi, Temperance, MI (US)

(21) Appl. No.: 17/943,453

(22) Filed: Sep. 13, 2022

(51) Int. Cl. H01M 50/211; H01M 50/26; H01M 50/289

(52) U.S. Cl. CPC H01M 50/211; H01M 50/26; H01M 50/289; H01M 2220/20

(57) ABSTRACT

A battery pack assembly includes a first cell stack having a first side and a second side. The first side is transverse to the second side. A second cell stack is adjacent the first side of first cell stack. A divider has a barrier portion and an attachment portion. The barrier portion is disposed between the first side of the first cell stack and the second cell stack. The attachment portion is secured directly to the second side of the first cell stack.

### TECHNICAL FIELD

This disclosure relates generally to barriers within a battery pack.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A traction battery pack assembly can power the electric machines.

### SUMMARY

In some aspects, the techniques described herein relate to a battery pack assembly, including: a first cell stack having a first side and a second side, the first side transverse to the second side; a second cell stack adjacent the first side of first cell stack; and a divider having a barrier portion and an attachment portion, the barrier portion disposed between the first side of the first cell stack and the second cell stack, the attachment portion secured directly to the second side of the first cell stack.

In some aspects, the techniques described herein relate to a battery pack assembly, wherein the first side of the first cell stack faces the second cell stack.

In some aspects, the techniques described herein relate to a battery pack assembly, wherein the attachment portion is adhesively secured to the second side.

In some aspects, the techniques described herein relate to a battery pack assembly, further including a double sided tape that secures the attachment portion to the second side.

In some aspects, the techniques described herein relate to a battery pack assembly, wherein the second side is a vertically upward facing side of the first cell stack.

In some aspects, the techniques described herein relate to a battery pack assembly, wherein the first cell stack and the second cell stack each include a plurality of pouch cells.

In some aspects, the techniques described herein relate to a battery pack assembly, wherein the divider includes a first and a second mica layer sandwiching a ceramic layer.

In some aspects, the techniques described herein relate to a battery pack assembly, wherein the divider includes a first and a second mica layer sandwiching a foam layer.

In some aspects, the techniques described herein relate to a battery pack assembly, wherein the divider includes a foam spacer attached to the barrier portion, the foam spacer configured to contact the first side to space the barrier portion from the first side.

In some aspects, the techniques described herein relate to a battery pack assembly, wherein the foam spacer is a first foam spacer attached to a first side of the barrier portion, and further including a second foam spacer attached to an opposite, second side of the barrier portion, the second foam spacer configured to contact the second cell stack to space the barrier portion from the second cell stack.

In some aspects, the techniques described herein relate to a battery pack assembly, further including a living hinge of the divider, the living hinge connecting the barrier portion to the attachment portion.

In some aspects, the techniques described herein relate to a battery pack assembly, further including a traction battery pack enclosure that encloses the first cell stack, the second cell stack, and the divider.

In some aspects, the techniques described herein relate to a battery pack assembly, wherein the first and second cell stacks are part of a traction battery pack assembly.

In some aspects, the techniques described herein relate to a method of routing flow within a battery pack, including: positioning a barrier portion of a divider adjacent a first side of a cell stack; and securing the barrier portion by attaching an attachment portion of the divider to an second side of the cell stack, the second side transverse to the first side.

In some aspects, the techniques described herein relate to a method, wherein the barrier portion is configured to redirect gases and debris vented from the first side of the cell stack.

In some aspects, the techniques described herein relate to a method, wherein the second side faces vertically upward, wherein the first side faces another cell stack within an enclosure of a traction battery pack.

In some aspects, the techniques described herein relate to a method, wherein the barrier portion is connected to the attachment portion via a living hinge.

In some aspects, the techniques described herein relate to a method, further including adhesively securing the second side to the second side of the cell stack.

In some aspects, the techniques described herein relate to a method, further including maintaining a spacing between the barrier portion and the first side of the cell stack using foam.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a traction battery pack.

FIG. 2 illustrates an expanded perspective view of a cell stack and a divider from the traction battery pack of FIG. 1.

FIG. 3 illustrates a perspective view of the traction battery pack with an enclosure cover of the traction battery pack removed.

FIG. 4 illustrates a section view taken at line 4-4 in FIG. 3 with the enclosure cover installed.

FIG. 5 illustrates a front view of one of the dividers from the traction battery pack of FIG. 1.

FIG. 6 illustrates a close-up view of an area of the section view of FIG. 4.

FIG. 7 illustrates a divider according to another exemplary aspect of the present disclosure.

### DETAILED DESCRIPTION

This disclosure details example traction battery pack assemblies having dividers positioned between cell stacks. The dividers can help redirect gas vented from one of the cell stacks away from other cell stacks of the assembly.

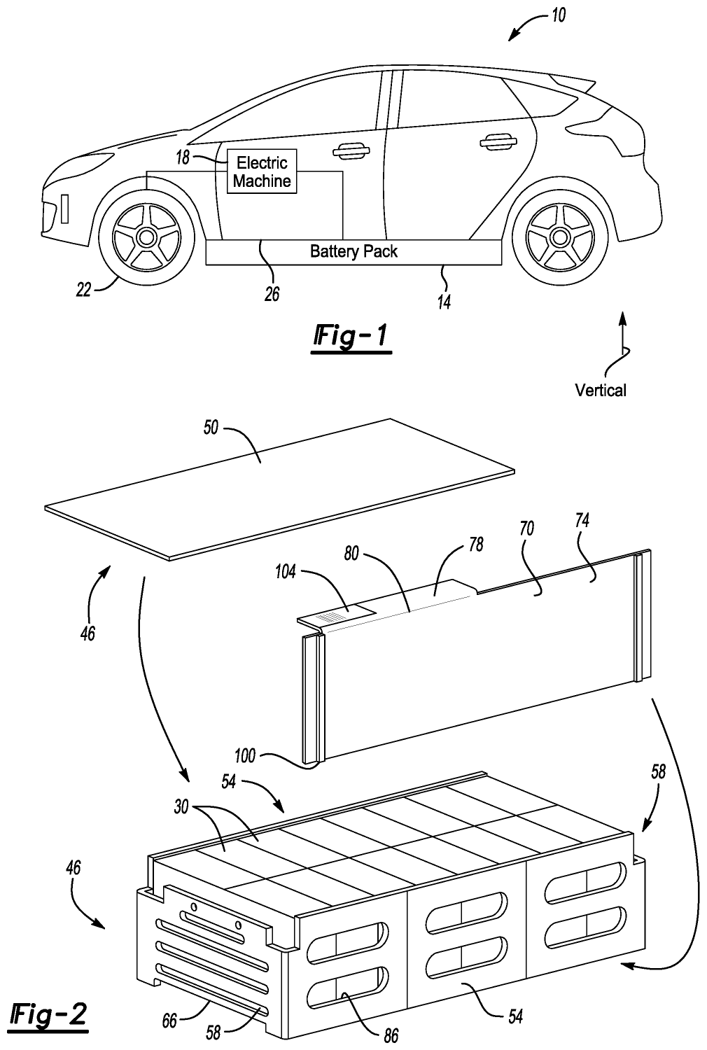

With reference to FIG. 1, an electrified vehicle 10 includes a traction battery pack assembly 14, an electric machine 18, and wheels 22. The traction battery pack assembly 14 powers an electric machine 18, which can convert electrical power to mechanical power to drive the wheels 22. The traction battery pack assembly 14 can be a relatively high-voltage battery.

The traction battery pack assembly 14 is, in the exemplary embodiment, secured to an underbody 26 of the electrified vehicle 10. The traction battery pack assembly 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

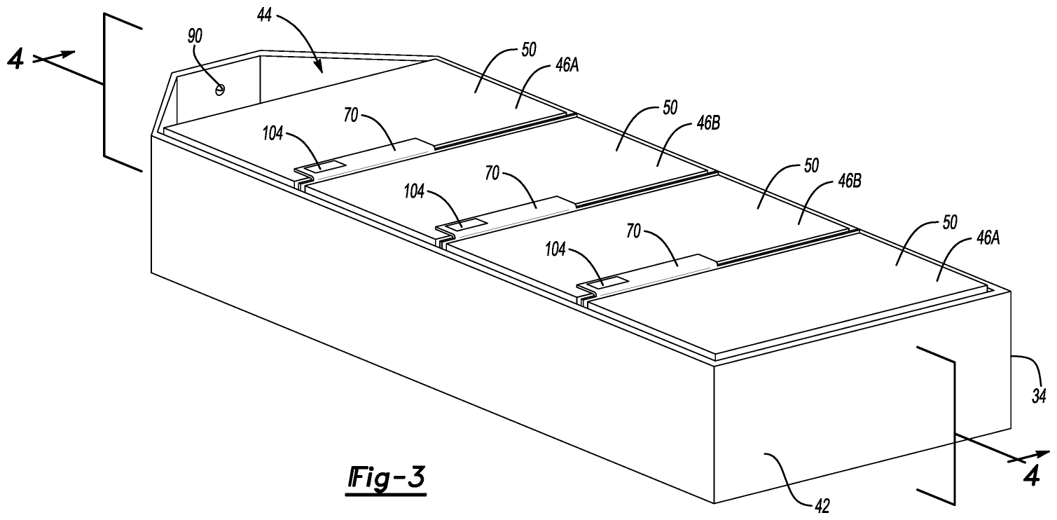

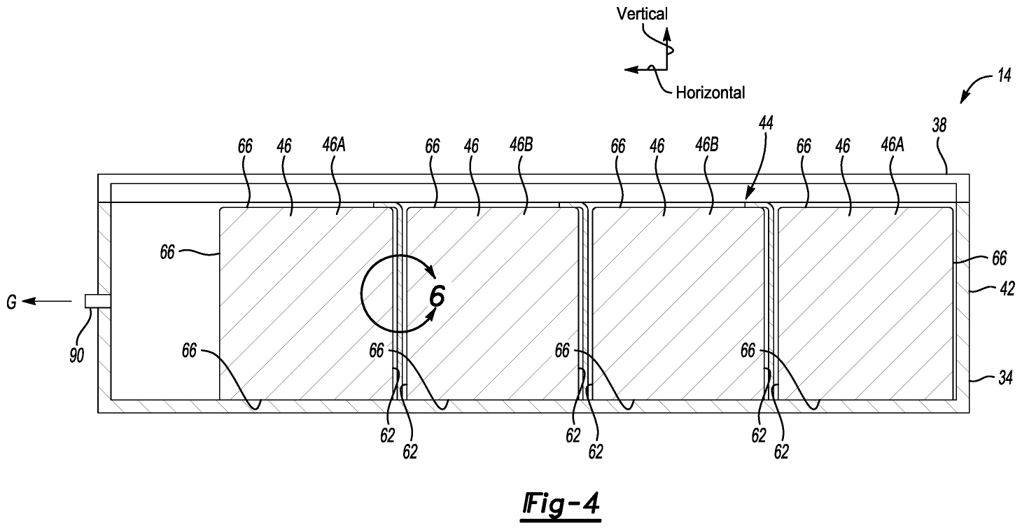

With reference now to FIGS. 2 to 6, the traction battery pack assembly 14 includes a plurality of individual battery cell assemblies 30 held within an enclosure assembly 34.

In the exemplary embodiment, the enclosure assembly 34 includes an enclosure cover 38 and an enclosure tray 42. The enclosure cover 38 is secured to the enclosure tray 42. The battery cell assemblies 30 and other components, such as busbars and control modules, are housed within an interior area 44 provided by the enclosure assembly 34.

The plurality of battery cell assemblies (or simply, “cells”) 30 are for supplying electrical power to various components of the electrified vehicle 10. Groups of the cells 30 are stacked side-by-side relative to one another along an axis to construct a cell stack 46. In this example, the battery pack 14 includes four cell stacks 46 within the interior area 44 of the enclosure assembly 34. The four cell stacks 46 are horizontally adjacent to each other. Horizontal and vertical, for purposes of this disclosure, are with reference to ground and a general orientation of the electrified vehicle 10 during operation.

Although a specific number of cells 30 and cells stacks 46 are illustrated in the various figures of this disclosure, the traction battery pack assembly 14 could include any number of cells 30 and cell stacks 46. In other words, this disclosure is not limited to the specific configuration of cells 30.

The cell stacks 46 include a top plate 50, side plates 54, and end plates 58. The top plate 50 covers the vertically upward facing sides of the cells 30, The side plates 54 are positioned alongside the opposing horizontally facing sides of the cells 30. The end plates 58 are disposed at opposing axial ends of the cell stacks 46.

In this embodiment, the cells 30 comprise lithium-ion pouch cells. One or more of the pouch cells can be held within a frame. In another example, the cell are prismatic cells. Battery cells having other geometries (cylindrical, jelly-roll, etc.) and/or chemistries (nickel-metal hydride, lead-acid, etc.) could alternatively be utilized within the scope of this disclosure.

For purposes of this disclosure, the cell stacks 46 each include one or two first sides 62 and a plurality of second sides 66. The first sides 62 are the side or sides of the cell stacks 46 that face another of the cell stacks 46 within the interior area 44 of the enclosure assembly 34. The second sides 66 are the other sides of the cell stacks 46—the sides that do not face another of the cell stacks 46. The second sides 66 include the sides that directly face the interior surfaces of the enclosure cover 38 or the enclosure tray 42. The first sides 62 are oriented transverse to some of the second sides 66.

In the exemplary embodiment, the cell stacks 46A each include one first side 62. The cell stacks 46B each include two first sides 62.

The battery pack 14 includes a plurality of dividers 70. Each of the dividers 70 has a barrier portion 74 and an attachment portion 78. The barrier portions 74 and the attachment portions 78 are connected to each other via a living hinges 80.

When the battery pack 14 is assembled, the attachment portions 78 are oriented transversely to the barrier portions 74. A gap between adjacent cell stacks 46 of the battery pack 14 can be, for example, four millimeters. The barrier portions 74 are positioned with this gap between cell stacks 46. The attachment portions 78 are used to secure the dividers 70.

In particular, the example attachment portions 78 are each folded over the top plate 50 of one of the cell stacks 46. The attachment portions 78 are secured directly to one of the top plates 50 to secure the divider 70. The attachment portions 78 can be secured using an adhesive. In an example, the attachment portions 78 are secured using double-sided tape 82. In other examples, the attachment portions 78 are secured by inserting at least some of the attachment portion into one of the cell stacks 46. The attachment portion 46 could be folded 180 degrees and be captured between the cells 30 and the side plate 54, for example. The attachment portion 46 could have mounting slots or key slots that receive extensions or “keys” extending from the top plate 50 to secure the dividers 70.

From time to time, temperature and pressure within one or more of the cells 30 can increase and cause the cell 30 to rupture and releases relatively high-temperature gases from inside the cell 30. In this example, the side plates 54 include a plurality of apertures 86 that permit the gases to flow from the cell stacks 46. In another example, apertures that are used to vent gas could instead or additionally be in the end plates 58.

The barrier portions 74 of the dividers 70 block gases G and debris released from one or more of the cells 30 through the apertures 86 in one of the cells stacks 46 from impinging on the adjacent cell stack 46 (see FIG. 6). The barrier portions 74 route the gases G and debris released from one or more of the cells 30 away from the adjacent cell stack 46. In particular, the barrier portions 74 redirect the gases G and debris vertically upward rather than toward the adjacent cell stack 46. The gases G and debris can be vented from the interior area 44 through a vent 90. Blocking the gases G and debris from impinging on the adjacent cell stack 46 can help to prevent thermal energy levels in the adjacent cell stack 46 from increasing such that the adjacent cell stack 46 experiences a thermal event. Blocking the gases can prevent formation of a conductive bridge between the adjacent cell stacks. The conductive bridge can be due to debris including particles of aluminum, copper, etc.

The dividers 70, in this example, are multilayered structures comprising first and second outer layers 94 that are mica. The outer mica layers 94 could be sheets of formed ceramics or polymers that are suitable for high-temperature environments. The outer layers 94 sandwich an internal layer 98 that is ceramic in this example. In another example, the internal layer 98 is foam. While this example uses two outer layers 94, other examples could utilize only one outer layer 94.

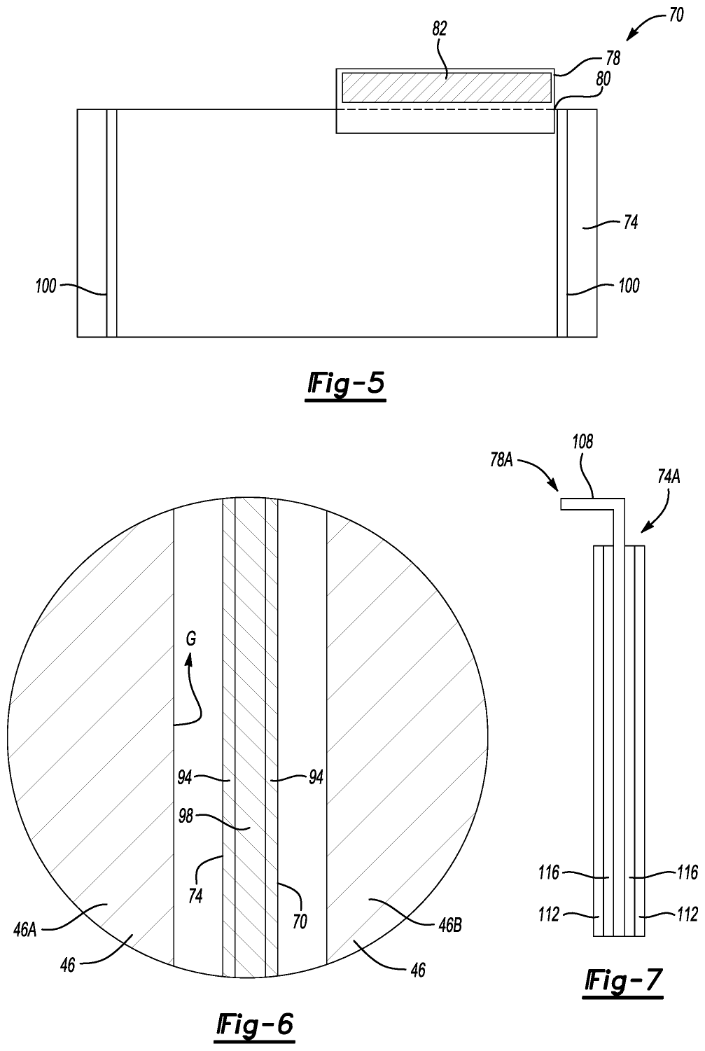

In some examples, the dividers 70 include spacers 100 attached to opposing sides of the barrier portions 74 (see FIG. 5). The spacers 100 are configured to contact the first sides 62 to space the barrier portions 74 from the first sides 62.

The spacers 100 can be foam strips that maintain the barrier portions 74 spaced from the cell stacks 46. The spacers 100 can also help to redirect the gases G into a desired portion of the interior area 44 so that the gases can be vented from the battery pack 14 through the vent 90. The spacers 100 can also help to reduce vibrations of the dividers.

In this example, an identifier 104 is secured to the attachment portions 78. During assembly, the cell stacks 46 can be placed in the interior area 44. The dividers 70 are then introduced between the first sides 62 of the cell stacks 46. A camera or similar optical recognition device can then scan the battery pack 14 to read the identifiers 104 and confirm the presence of the dividers 70.

With reference to FIG. 7, another example divider 70A for use within the battery pack 14 includes an inner layer 108 that is mica. In a barrier portion 74A of the divider 70A, the inner layer 108 is sandwiched between endothermic intumescent aerogel sheets 112. Pieces of double-sided tape 116 are used to secure the sheets 112 to the barrier portion 74A. An attachment portion 78A of the divider 70A is a continuation of the mica sheet that provides the inner layer 108. The attachment portion 78A lacks the sheets 112 in this example.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack assembly, comprising:
a first cell stack having a first side and a second side, the first side transverse to the second side;
a second cell stack adjacent the first side of first cell stack; and
a divider having a barrier portion and an attachment portion, the barrier portion disposed between the first side of the first cell stack and the second cell stack, the attachment portion secured directly to the second side of the first cell stack.

2. The battery pack assembly of claim 1, wherein the first side of the first cell stack faces the second cell stack.

3. The battery pack assembly of claim 1, wherein the attachment portion is adhesively secured to the second side.

4. The battery pack assembly of claim 1, further comprising a double sided tape that secures the attachment portion to the second side.

5. The battery pack assembly of claim 1, wherein the second side is a vertically upward facing side of the first cell stack.

6. The battery pack assembly of claim 1, wherein the first cell stack and the second cell stack each include a plurality of pouch cells.

7. The battery pack assembly of claim 1, wherein the divider comprises a first and a second mica layer sandwiching a ceramic layer.

8. The battery pack assembly of claim 1, wherein the divider comprises a first and a second mica layer sandwiching a foam layer.

9. The battery pack assembly of claim 1, wherein the divider includes a foam spacer attached to the barrier portion, the foam spacer configured to contact the first side to space the barrier portion from the first side.

10. The battery pack assembly of claim 9, wherein the foam spacer is a first foam spacer attached to a first side of the barrier portion, and further comprising a second foam spacer attached to an opposite, second side of the barrier portion, the second foam spacer configured to contact the second cell stack to space the barrier portion from the second cell stack.

11. The battery pack assembly of claim 1, further comprising a living hinge of the divider, the living hinge connecting the barrier portion to the attachment portion.

12. The battery pack assembly of claim 1, further comprising a traction battery pack enclosure that encloses the first cell stack, the second cell stack, and the divider.

13. The battery pack assembly of claim 1, wherein the first cell stack and the second cell stack are part of a traction battery pack assembly.

14. A method of routing flow within a battery pack, comprising:
positioning a barrier portion of a divider adjacent a first side of a cell stack; and
securing the barrier portion by attaching an attachment portion of the divider to an second side of the cell stack, the second side transverse to the first side.

15. The method of claim 14, wherein the barrier portion is configured to redirect gases and debris vented from the first side of the cell stack.

16. The method of claim 14, wherein the second side faces vertically upward, wherein the first side faces another cell stack within an enclosure of a traction battery pack.

17. The method of claim 14, wherein the barrier portion is connected to the attachment portion via a living hinge.

18. The method of claim 14, further comprising adhesively securing the second side to the second side of the cell stack.

19. The method of claim 14, further comprising maintaining a spacing between the barrier portion and the first side of the cell stack using foam.
